(19) United States
(12) Patent Application Publication
(10) Pub. No.: US 2026/0258904 A1
(43) Pub. Date: Sep. 3, 2026

(54) A LUBRICANT-IMPREGNATED FABRIC FOR CLEANING AND/OR LUBRICATING FIREARMS

(71) Applicant: SMS CHEMICALS LTD, Tel-Aviv (IL)

(72) Inventors: Amos LEVI, Ashqelon (IL); Moti LAHAT, Ramat Hasharon (IL)

(73) Assignee: SMS CHEMICALS LTD, Tel-Aviv (IL)

(21) Appl. No.: 19/489,977

(22) PCT Filed: Jun. 6, 2024
(86) PCT No.: PCT/IL2024/050564

§ 371 Date: Dec. 4, 2025

(30) Foreign Application Priority Data
Jun. 6, 2023 (IL) 303528

(51) Int. Cl. F16N 3/00; D06B 3/10

(52) U.S. Cl. CPC F16N 3/00; D06B 3/10

(57) ABSTRACT

The invention includes an article for cleaning and/or lubricating a firearm, with a sealable container, a woven lint-free fabric, and a lubricant; wherein the fabric is impregnated with the lubricant, and wherein the fabric comprises at least 90% cotton and wherein the fabric-to-lubricant ratio is in the range of 0.5:1 to 1:0.5.

### FIELD OF THE INVENTION

The invention relates to a novel product for applying gun oil composition to modern firearms.

### BACKGROUND OF THE INVENTION

Firearms (such as guns, pistols, rifles etc.) have a need for constant maintenance, including cleaning and lubrication, to ensure that they are in working condition. Lubrication improves their activity and preserves the metals condition. Absorbent fabrics, such as cotton fabrics, are commonly used for cleaning modern weapons/guns and for applying lubrication, such as gun oil. As trivial as it sounds, military and civil firearm users are facing many challenges starting with relatively strict requirements of various, especially military, specifications versus the costs and the availability of the materials; lack of means to control the amount of lubricant (oils) spent in each and every action, leading to significant “waste” of the lubricant that may lead to potential environmentally hazardous effect, “waste” of the means (cloth or other) used for each lubrication resulting in lack of efficiency and higher costs. The urgency in addressing the above challenges stems from the fact that any weapon must be cleaned and/or lubricated frequently to ensure safe usage, and the budget and efficiency of such a basic process is critical for large organizations, such as the military.

Currently proposed solutions fail to resolve the above issues and to provide a comprehensive, simple and holistic answer to the above challenges. Thus, the development of lubrication/cleaning solutions remains a long and unmet need.

### SUMMARY OF THE INVENTION

It is a principal object of the present invention to provide a holistic, simple, user-friendly and cost-effective solution for weapon lubrication and cleaning.

According to some embodiments, the invention provides an article for cleaning and/or lubricating a firearm, comprising a sealable container, a woven lint-free fabric, and a lubricant; wherein the fabric is impregnated with the lubricant, and wherein the fabric comprises at least 90% cotton and wherein the fabric-to-lubricant ratio is in the range of 0.5:1 to 1:0.5.

It is another object of the present invention to provide the article according to the above, wherein the fabric-to-lubricant ratio is in the range of 1:0.6 to 1:1. It is another object of the present invention to provide the article according to the above, wherein the fabric-to-lubricant ratio is in the range of 1:0.8 to 1:1.

It is another object of the present invention to provide the article according to the above, wherein the fabric is characterized by at least one of: a warp density in the range of 30/1 to 35/1 threads, a warp density in the range of 19-to-23 threads per cm², weft density in the range of 10/1 to 15/1 threads, weft density in the range of 19-to-23 threads per cm², a weight of 125 to 150 g/m², a weight of 137±10 g/m², plain or twill weave, having less than 2% starch and protein, a warp breaking strength of at least 20 kg. (45 pounds), a weft breaking strength of at least 13.5 kg (30 pounds), a warp dry tearing strength of at least 880 grams, a weft dry tearing strength of at least 480 grams, containing 250 parts per million (ppm) or less of water leachable sulfur, containing 250 ppm or less of each of water leachable halides (fluoride, chloride, and bromide), or any combination thereof.

It is another object of the present invention to provide the article according to the above, wherein the fabric is free from loose threads, ravelings, lint and fluff.

It is another object of the present invention to provide the article according to the above, wherein the fabric conforms to any one of MIL-DTL-24671A, MIL-DTL-24671A, MIL-DTL-24671B, MIL-DTL-24671C, MIL-DTL-24671, MIL-C-24671, NSN 7920-00-044-9281, NSN 7920-01-470-3786.

It is another object of the present invention to provide the article according to any of the above, wherein the lubricant conforms to at least one of VV-L-800, VV-L-800A, VV-L-800B, VV-L-800C, VV-L-820, MIL-PRF-32033, MIL-PRF-32033A or MIL-PRF-14107.

It is another object of the present invention to provide the article according to any of the above, wherein the container is selected from the group consisting of bucket, box, bag, packet, jar, dispenser, pouch, barrel, can, drum and tub.

It is the object of the present invention to provide a method of producing a lubricant-impregnated fabric for cleaning and/or lubricating a firearm, comprising:
a. providing a lint-free fabric and a lubricant;
b. applying the lubricant to the fabric in the ratio in the range of 1:0.5 to 0.5:1 fabric-to-lubricant;
c. and placing the impregnated fabric in an air and/or liquid tight sealable container.

It is another object of the present invention to provide the method according to the above, wherein the fabric is in the form of a continuous strip, and wherein the method further comprises a step of pre-cutting, partially pre-cutting or perforating the fabric at predetermined intervals.

It is another object of the present invention to provide the method according to any of the above, wherein the step of precutting comprises cutting at least 75% of the width of the fabric.

It is the object of the present invention to provide a method of lubricating a firearm, comprising the steps of:
a. providing the article according to any of the above;
b. extracting at least one segment of the fabric from the container; and
c. applying lubricant to the firearm;

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In order to understand the invention and to see how it may be implemented in practice, a plurality of embodiments is adapted to now be described, by way of non-limiting example only, with reference to the accompanying drawings; wherein:

FIG. 1A-B is a schematic illustration of the fabric roll of the present invention.

FIG. 2A-C is a schematic representation of the article of the present invention.

### DETAILED DESCRIPTION OF THE INVENTION

The present invention is now described more fully hereinafter with reference to the accompanying examples and drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

According to some embodiments, the invention provides an article for cleaning and/or lubricating a firearm, comprising a sealable container, a woven lint-free fabric, and a lubricant; wherein the fabric is impregnated with the lubricant, and wherein the fabric-to-lubricant ratio is in the range of 1:0.5 to 0.5:1. According to some embodiments of the present invention, the fabric-to-lubricant ratio is in the range of 1.0:0.6 to 1:1. In to some embodiments, the fabric-to-lubricant ratio is in the range of 1:0.8 to 1:1.

The term ‘firearm’ refers, without limitation, to any number of barreled weapons that can launch one or more projectiles (which can referred to as a bullet) driven by rapidly expanding high-pressure gas produced by exothermic combustion (deflagration), mainly of a chemical propellent (smokeless gun power is commonly used). In the context of the invention, the non-limiting list of firearms includes barreled guns, rifles, handguns, pistols, revolvers, shotguns, machine or submachine guns, automatic or semiautomatic guns, carabines, or any other firearm that can benefit from the subject invention.

According to some embodiments of the above-article, the firearm of the invention is at least partially constructed from a metal. A non-limiting list of metals suitable for the firearms of the invention includes iron, steel, that needs constant cleaning and/or lubricating for safe operation and storage.

In the context of the invention, the term ‘lubricant’ refers to a substance that can be used to reduce friction between two or more surfaces that are in mutual contact. Lubrication can act to reduce the heat generated when the surfaces move, transmitting of forces, transporting foreign particles, or heating or cooling the surfaces. In some embodiments, the lubricant is liquid (such as oil). In some embodiments, the lubricant is a solid (such as grease).

According to some embodiments of the above article, the lubricant comprises at least 75% base oil. and up to 25% additives.

The term ‘base oil’ is used to refer to an oil typically comprising the majority (often at least 75%) of the lubricant. A base oil can be characterized as comprising mineral oil(s), vegetable oil(s) or synthetic liquid(s) or oil(s), or any mixture thereof.

The term ‘mineral oil’ can be used to describe a variety of various colorless, odorless, light mixtures of higher alkanes from a mineral source, particularly a distillate of petroleum.

The term ‘vegetable oil’ is used to describe oils extracted from seeds or from other parts of fruits, such as soybean oil, grape seed oil, olive, palm oil, and rice bran oil. The term ‘bio-lubricant’ can be used to describe lubricants containing oils from renewable sources, such as vegetable or animal oils.

The term ‘synthetic oils’ is used to describe chemical compounds that are chemically modified or synthesized. Synthetic oils, or liquids, can be produced from modified petroleum components rather than whole crude oil, but can also be synthesized from other raw materials. Synthetic oils can be hydrogenated polyolefins, esters, silicones or fluorocarbons.

Lubricants commonly contain (oil) additives, typically comprising up to 25% by weight, that can improve the lubricants physical and/or chemical performance, such as reduced friction and wear, increased viscosity, improved viscosity index, resistance to corrosion and/or oxidation, aging or contamination, etc. The additive could be corrosion inhibitors, anti-wear agents, pour-point depressants, antioxidants, metal deactivators and any other commonly used additive.

As used herein the term “impregnated” is used to describe a state wherein a liquid (such as an oil) is absorbed by a fabric. This term is interchangeable with terms such as “loaded”, “soaked”, and “incorporated”.

The term ‘absorption’ is used to describe the process by which a substance, incorporated in one state or phase, is transferred into another substance, in a different state (e.g., liquid being absorbed by a solid, such as an oil being absorbed by a fabric).

In some embodiment, the fabric is impregnated in a ratio of 1:0.5 to 0.5:1, fabric-to-lubricant by weight. In some embodiments the ratio is 0.5:1, 0.6:1, 0.7:1, 0.8:1, 0.9-1, 1:1, 1:0.9, 1:0.8, 1:0.7, 1:0.6, or 1:0.5 fabric-to-lubricant, by weight.

According to some embodiments of the above-article, at least 90% of the absorbed lubricant is stable for at least 6 months.

According to some embodiments, the fabric is characterized by being free from imperfections, such as loose thread, ravelings, lint and fluff, from cloth, thread or yarn or particles of a size visible to the unaided eye. According to some embodiments, the cloth is further free of any visible contaminations or foreign particulate matter, such as dirt, dust or grease either embedded in the cloth or adhering thereto. In some embodiments, the integrity of the textile is verified by visual inspection. As used herein, the term “free of” refers, without any limitation, to refer to a cloth with no more than 5 (<5) specks or stains, with no speck or stain exceeding 2 mm in any dimension.

According to some embodiments of the above-article, the fabric is composed of 90-100% cotton. According to some embodiments, the fabric can be evaluated according to any one of method 1200 of Federal test method standard No. 191, Identification of Cotton, Flax, Hemp, Ramie and Jute (also referred to as 1200/FED-STD-191), American Association of Textile Chemists and Colorists method ‘Evaluation Procedure for Multifiber Adjacent Fabrics’ (AATCC-10, https://members.aatcc.org/store/ep10/467/), or ‘Test Method for Fiber Analysis: Qualitative’ (TM020-TM20-TM 2 or AATCC-20, https://members.aatcc.org/store/tm20/485/).

According to some embodiments of the above article, the fabric is flannel or flannelette. The term ‘flannelette’ is used to describe, without limitation, a soft and/or napped cotton fabric that imitates the texture of flannel. In many cases the weft (also referred to as the pick or filling) is coarser than the warp. The flannel-like texture is often created by creating a nap from the weft (scratching and raising the weft up). Flannelette can either have long or short ‘nap’ and can be ‘napped’ on one or two sides. As used herein, the term ‘nap’ is used, without limitation, to describe the raised (fuzzy) surface on certain kinds of cloth, as part of the fabrics finishing process. After the cloth is woven, it goes through processes such as washing, fulling, raising and trimming the nap.

According to some embodiments of the above-article, the fabric is characterized as being woven. In some embodiments, the fabric has plain or twill weave. In general, the two basic components of a woven fabric are ‘Warp’ (the longitudinal yarn, sometimes referred to as woof) and ‘Weft’ (which traverses the welf and can also be referred to as the fill or filling yarn). The fabric is woven by holding the lengthwise or longitudinal warp yarns stationary with tension (often on a frame or a loom), while the transverse weft is drawn through and inserted over and under the warp. A single thread of the weft that crosses the warp is called a pick, with each individual warp thread in a fabric is referred to as a warp end or end. The terms ‘warp density’ and ‘weft density’ refer, without limitation, to the number of picks or warp ends per inch (presented as n/1), or number of threads per square centimeter (presented as threads per cm²).

According to some embodiments of the above-article, the fabric has a weft that is coarser than the warp and having at least one ‘nap’. In some embodiments, the fabric is characterized by having a warp density of about 30-to-35 warp ends per inch (30-35/1) and a weft density of about 10-to-35 picks per inch (30-35/1) when tested according to Standard Test Method-D-3775 (STM-D-3775): Standard Test Method for End (Warp) and Pick (Filling) Count of Woven Fabrics (https://www.astm.org/d3775-17e01.html).

According to some embodiments of the above-article, the fabric is characterized by having a warp density of about 19-23 threads per cm², and a weft density of about 19-23 threads per cm², when tested according to Standard Test Method-D-3775 (STM-D-3775): Standard Test Method for End (Warp) and Pick (Filling) Count of Woven Fabrics (https://www.astm.org/d3775-17e01.html). In some embodiments, the fabric is characterized by having a warp density of about 20-22 threads per cm², and a weft density of about 20-22 threads per cm²,

According to some embodiments of the above-article, the fabric comprises less than 2% starch and protein, when tested according to method 2611 of Federal test method standard No. 191, Nonfibrous Materials in Cotton, Enzyme Method (also referred to as 2611/FED-STD-191).

According to some embodiments of the above-article, the fabric has a warp breaking strength of at least 45 pounds and a weft breaking strength of at least 13.5 Kg. (or 30 pounds), when tested according to method 5100 of Federal test method standard No. 191, Strength and Elongation, Breaking of Woven Cloth; Grab Method (also referred to as 5100/FED-STD-191).

According to some embodiments of the above-article, the fabric has a warp dry tearing strength of at least 880 grams and a weft dry tearing strength of at least 480 grams, when tested according to Standard Test Method-D-1424 (ASTM D 1424): Standard Test Method for Tearing Strength of Fabrics by Falling-Pendulum (Elmendorf-Type) Apparatus (https://www.astm.org/d1424-21.html).

According to some embodiments of the above-article, the fabric contains no more than 250 parts per million (ppm) (or micrograms per gram) of water leachable sulfur or 250 ppm (or micrograms per gram) each of water leachable halides (fluoride, chloride, and bromide), when tested according to according to USA Department of Defense Standard Practice: Evaluation of Quality of Textile Materials (MIL-STD-3064).

According to some embodiments of the above-article the fabric has a weight of 137±15 (125-150) g/m², when tested according to Standard Test Method-D-3776 (ASTM-D-3776): Standard Test Methods for Mass Per Unit Area (Weight) of Fabric (https://www.astm.org/d3776_d3776m-20.html).

According to some embodiments of the above-article, the fabric can be is in compliance with relevant specifications, such as Military Specification: Cloth, Lint-free, Flushing and Cleaning (also referred to as MIL-DTL-24671 or MIL-C-24671), or a Cleaning cloth according to NSN 7920-00-044-9281 (also referred to as NSN 7920000449281), or NSN 7920-01-470-3786 (also referred to as NSN 7920014703786), or any other relevant specification.

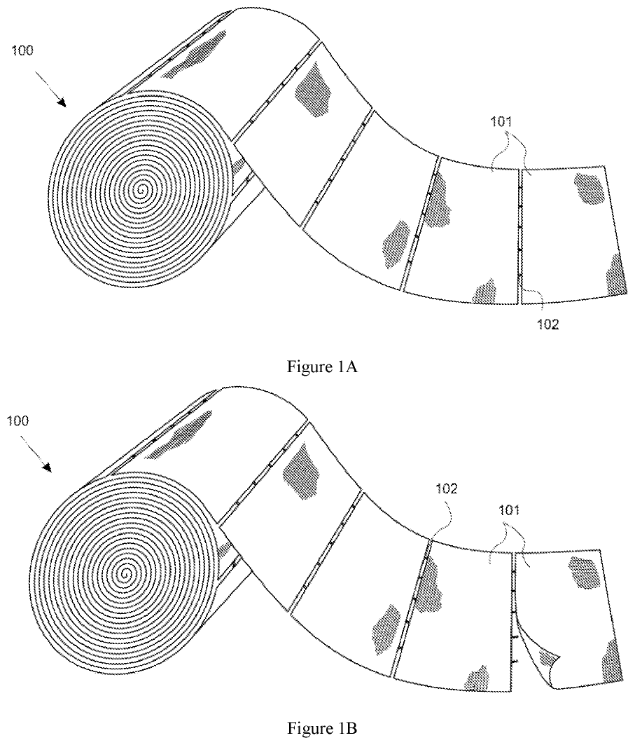

According to some embodiments of the above article, the fabric is pre-cut. In the context of the invention the term “pre-cut” refers, without limitation, to detaching segments of the fabric from the rest of the cloth. According to some embodiments, the fabric is partially pre-cut, and/or perforated (placing a plurality of holes in the fabric). In the context of the invention the term “partially pre-cut” refers, without limitation, to partially detaching segments of the fabric from the rest of the cloth or to create a partial detachment between segments of the fabric. In the context of the invention the term “perforated” refers, without limitation, to a plurality of holes in the fabric in an organized manor. In some embodiments of the above article, the fabric comprises lines of perforation. In some embodiments of the above article, the fabric is characterized by having an oil absorption of at least 20 g/g. In some embodiments of the above article, the fabric is characterized by having an oil absorption of at least 25, 30, 35 g/g. Reference is made to FIG. 1A, showing a roll of fabric 100, with a plurality of segments 101, separated by a perforation 102, with FIG. 1B, demonstrating the separation of the segments 101 along a line of perforation 102.

According to some embodiments of the above article, the lubricant is characterized by having a viscosity index of 40±10 at 40° C. (according to Standard Test Method for Kinematic Viscosity of Transparent and Opaque Liquids (and Calculation of Dynamic Viscosity), ASTM D 445, https://www.astm.org/standards/d445).

According to some embodiments of the above article, the lubricant is characterized by having a kinematic viscosity of at least 11±1.1 centistokes at 40° C., no more than 7,000±700 centistokes at 40° C., and no more than 60,000±600 centistokes at −54° C. (according to Standard Test Method for Kinematic Viscosity of Transparent and Opaque Liquids (and Calculation of Dynamic Viscosity), ASTM D 445, https://www.astm.org/standards/d445).

According to some embodiments of the above article, the lubricant is characterized by having a kinematic viscosity of at least 5.8±2.5 centistokes at 37.8° C., and no more than 950±200 centistokes at −54° C. (according to Standard Test Method for Kinematic Viscosity of Transparent and Opaque Liquids (and Calculation of Dynamic Viscosity), ASTM D 445, https://www.astm.org/standards/d445).

According to some embodiments of the above article, the lubricant is characterized by having a density of 0.88±0.3 g/m³ at 15° C.

According to some embodiments of the above article, the lubricant is characterized by having a flashpoint of at least 135° C. (according to Standard Test Method D92 (ASTM D 92): Standard Test Method for Flash and Fire Points by Cleveland Open Cup Tester, https://www.astm.org/standards/d92).

According to some embodiments of the above article, the lubricant is characterized by having a flashpoint of at least 162° C. (according to Standard Test Method D92 (ASTM D 92): Standard Test Method for Flash and Fire Points by Cleveland Open Cup Tester, https://www.astm.org/standards/d92). According to some embodiments, of the above article, the lubricant is characterized by having a flashpoint of 190° C. (according to Standard Test Method D92 (ASTM D 92): Standard Test Method for Flash and Fire Points by Cleveland Open Cup Tester, https://www.astm.org/standards/d92).

According to some embodiments, of the above article, the lubricant is characterized by having a lowest pour point of no higher than −60° C. (according to Standard Test Method D92 (ASTM D 97): Standard Test Method for Pour Point of Petroleum Products, https://www.astm.org/standards/d97).

According to some embodiments of the above article, the lubricant is characterized by having an evaporation loss of less than 25% at 100° C. (according to Standard Test Method D972 (ASTM D 972): Standard Test Method for Evaporation Loss of Lubricating Greases and Oils, https://www.astm.org/standards/d972).

According to some embodiments, of the above article, the lubricant is characterized by having a maximum precipitation number of the insoluble materials of less than 0.05 ml (according to Standard Test Method D91 (ASTM D 91): Standard Test Method for Precipitation Number of Lubricating Oils, https://www.astm.org/d0091-02r19.html).

According to some embodiments of the above article, the lubricant is characterized by inhibiting the rusting of ferrous metals for at least 400 hours in a high humidity environment (according to method 5326 of Federal test method standard No. 791 (5326/FED-STD-791): Federal Standard: Testing Method of Lubricants, Liquid Fuels, And Related Products).

According to some embodiments of the above article, the lubricant does not precipitate or isn't separating when stored at −54° C. for 168 hours.

According to some embodiments of the above article, the lubricant does not precipitate or separate when stored for six months at 18.3 to 35° C.

According to some embodiments of the above article, the lubricant is characterized as having low temperature stability at −45° C. for at least 72 hours, described as not exhibit any gelling, crystallization, solidification, or separation of insoluble material (according to method 3458 of Federal test method standard No. 791 (3458/FED-STD-791): Federal Standard: Testing Method of Lubricants, Liquid Fuels, And Related Products).

According to some embodiments of the above article, the lubricant is characterized as being stable in contact with water.

According to some embodiments of the above article, the lubricant is characterized by having corrosion prevention following 192 hours in humid conditions (according to ASTM D1748: Standard Test Method for Rust Protection by Metal Preservatives in the Humidity Cabinet, https://www.astm.org/d1748-22.html).

In some embodiments of the above article, the lubricant is a gun oil or a lubricant.

According to some embodiments of the above article, the lubricant conforms with, without limitation, the following specifications: Lubricating Oil, General Purpose, Preservative, (Water-Displacing, Low Temperature) (such as VV-L-800, including A/B/C), Lubricating Oil, General Purpose (Light) (such as VV-L-820), Performance Specification Lubricating Oil, General Purpose, Preservative (Water-Displacing, Low Temperature) (Such As MIL-PRF-32033 (Including A), Performance Specification Lubricating Oil, Weapons, Low Temperature (Such As MIL-PRF-14107), Military Specification: Lubricant, Semi-Fluid (Automatic Weapons) (such as MIL-L-46000C), Lubricant, All-Weather, (Automatic Weapons) (such as MIL-PRF-85336), Military Specification: Lubricant, Weapons, Semi-Fluid (High Load-Carrying Capacity) (such as MIL-L-46150), or any other relevant specification that may be beneficial for the subject invention.

According to some embodiments, the present invention provides a dispenser for lubricant-impregnated fabric for cleaning and/or lubricating a firearm.

According to some embodiments, the above dispenser comprises a container, configured to hold the lubricant-impregnated fabric.

According to some embodiments of the above dispenser, the container comprises one side having a lid and/or an opening, configured to enable access and extraction of at least one section of the impregnated fabric. In the context of the invention, the term “lid” is interchangeable with the terms such as cover, cap, closure, or plug. The container can be constructed from a material such as, without limitation, nylon, plastic, metal, or any other material. The container can have hard sides, having a degree of stiffness or rigidity to retain its shape while holding the article. Alternatively, the container might have soft sides, partially folding while containing the article. In the context of the invention, a non-limiting list of containers includes a bag, sachet, packet, jar, dispenser, pouch, barrel, can, drum, tub, box, or bucket.

According to some embodiments of the above dispenser, the opening can be made from nylon, plastic, rubber, or silicon. In some embodiments, the opening can be a slit, with the slit being, without limitation, straight, curved, round, wavy, V- W-, T- or X-shaped, or any combination thereof. In some embodiments, the opening can have 2 or more branches. In some embodiments, the opening can be fully or partially water-tight and/or air-tight. In the context of the invention, the term ‘water-tight’ refers to a container having substantially no liquid leakage. In the context of the invention, the term ‘air-tight’ refers to a container having substantially no leakage of gas or liquids.

According to some embodiments of the above dispenser, the opening further comprises a cap. The cap can be, without limitation, attached, partially detached, or detached from the opening, to enable access to the slit. In some embodiments, the cap can be attached or detached by a variety of mechanisms, including, without limitation, by screw threads or snap fit, etc. In some embodiments, the cap and/or the slit are configured to pop- or rise-up.

According to some embodiments of the above dispenser, the fabric can be, without limitation rolled, folded, pre-cut, partially pre-cut, or perforated. In some embodiments, the fabric can be partially connected, loosely connected, detached, partially detached, interconnected, forming a web, continuously folded, or any combination thereof. In the context of the invention, the term ‘connected’ refers to segments of the fabric that are at least partially physically linked, adjoined, integrated, or joined. In some embodiments, the sheets are 1-20% connected, as a portion of the adjacent edge. In some embodiments, the fabric forms a roll of continuous interconnected or partially connected sheets. In some embodiments, the fabric comprises a stack of individual sheets that are continuously interconnected. In some embodiments, the trailing edge of a leading sheet or segment is configured to position the successive segment of sheet to be extracted.

According to some embodiments of the above dispenser, the fabric can be pre-cut, partially pre-cut, or perforated by using a needle or a narrow, serrated, sawed, or toothed blade. In some embodiments, the blade covers at least 75% of the width of the fabric. In some embodiments, the blade covers at least 85% of the width of the fabric.

According to some embodiments of the above dispenser, the fabric can be positioned with the face or an edge of the fabric opposite the opening or gasket.

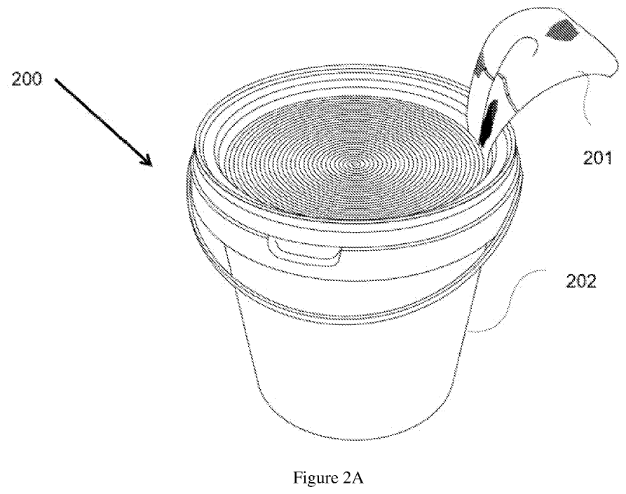

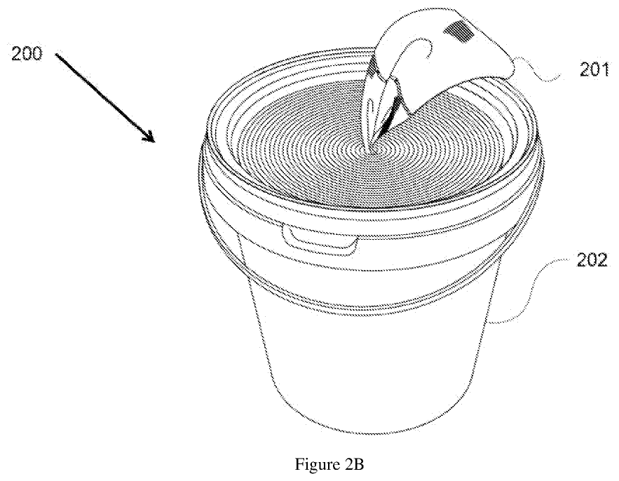

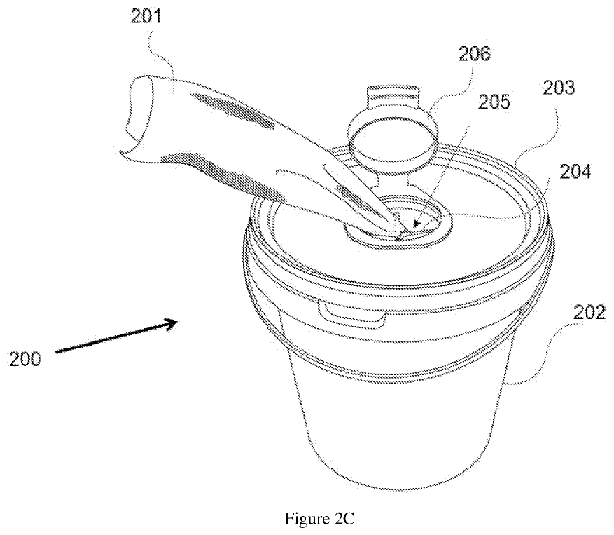

Reference is made to FIG. 2A-B, showing the article of the present invention 200 that serves as a dispenser. The roll of fabric 201 is placed in a hard-sided container 202. The fabrics free end or leading segment or sheet 201 can be extracted from the outer edge of the roll FIG. 2A or from the center FIG. 2B. FIG. 2C shows the article of the present invention 200, placed in a ridge container 202, that is then closed with a lid 203. The container's lid 203 further has an opening 204 to enable removal of the fabric 201 through an X-shaped slit 205, that can be closed with a cap 206.
a) According to some embodiments of the present invention, the invention provides a method of preparing an impregnated fabric, comprising the steps of: Providing a fabric according to one or more of the above embodiments.
   In some embodiments, the fabric can be a flannelette comprising at least 90% cotton, having a weight of 137±15 gr/m² (as described above).
   In some embodiments, the method further comprises a step of cutting, at least partially cutting and/or perforating the fabric. According to some embodiments, 75-99% of the fabric can be cut and/or perforated. In some embodiments, 85-95% of the fabric can be cut and/or perforated. The fabric can be in a roll or in sheets. The sheets can be folded or interconnected.
b) Applying the lubricant to the fabric.

According to some embodiments of the above method, the lubricant can be applied by, without limitation, injecting, spraying, or any other commonly used method. The fabric can be sprayed with 0.5-to-2-gram lubricant per 1 gram fabric.

According to some embodiments of the above method, the lubricant is a firearm or a gun oil.

According to some embodiments of the above method the lubricant can be characterized, without limitation, according to any of the relevant specifications described in one or more of the above embodiments.

According to some embodiments of the above method, the lubricant comprises at least 75% base oil. and up to 25% additives.

According to some embodiments of the above method, the fabric and the lubricant are rested for a period of at least 1 hour to enable absorption, before use. In some embodiments, the rest period enables full absorption of the lubricant.

According to some embodiments of the above method, the impregnated fabric is placed in an air and/or liquid tight container. The container can have an opening for accessing the fabric and extraction a desired section. The opening can be resealable.

According to some embodiments of the invention, the lubricant remains absorbed by the fabric for at least 6 months.

### EXAMPLES

In the examples below, if an abbreviation is not defined above, it has its generally accepted meaning. Further,

### Example 1

A roll of fabric (cotton flannelette, 0.10 M width, 150 M length, 137 g/m²) was sprayed with 1.8 Kg. VV-L-800C compliant lubricant, using a nozzle. The impregnated fabric was placed in an air and liquid tight nylon package. The package was sealed and placed in a cardboard box.

### Example 2

A roll of fabric (cotton flannelette, 0.10 M width, 70 M length, 137 g/m², with a perforation every 0.1 M) was sprayed with 0.85 Kg. VV-L-800C compliant lubricant using a nozzle. The impregnated fabric was placed in a plastic bucket (diameter of 35 cm, height of 25 cm). The bucket was then closed with a lid, having an X-shaped slit, with the slit being covered by a resealable plastic cap.

### Example 3

20 continuously C-folded sheets of fabric (cotton flannelette, 30*15 cm, 140 g/m²) was sprayed with 0.11 Kg. of a VV-L-800C compliant lubricant. The impregnated fabric is sealed by two sheets of plastic, to form a sachet (20 cm×20 cm). The sachet has an X-shaped slit, with the slit being covered by a resealable plastic cap.

### Testing

11 different product samples were prepared, with 6 being prepared from non-woven fabrics (MW1-6) and 5 from woven fabrics (W1-5).

The non-woven fabric was a cotton-viscose mixture, 20% cotton and 80% viscose (the highest cotton content available), with a weight of 90-to-110 g/m² (110 g/m² is the highest available fabric weight).

The different fabrics were evaluated at different lubricant-to-fabric ratios (by weight), using a VV-L-800C compatible firearm lubricant from Paz Oil (#9105).

TABLE 1
Lubricant-impregnated fabrics

| | Fabric | | | Lubricant- |
|---|---|---|---|---|
| | | Weight | | to- |
| Sample | Structure | (g/m²) | Composition | Fabric ratio |
| NW1 | Non- | 90 | Cotton- | 0.30:1.0 |
| NW2 | Woven | | Viscose | 0.40:1.0 |
| NW3 | | | (20:80) | 0.50:1.0 |
| NW4 | | 100 | | 0.55:1.0 |
| NW5 | | 110 | | 0.60:1.0 |
| NW6 | | | | 0.70:1.0 |
| W1 | Woven | 140 | Cotton | 0.70:1.0 |
| W2 | | | (100%) | 0.80:1.0 |
| W3 | | | | 0.90:1.0 |
| W4 | | | | 1.00:1.0 |
| W5 | | | | 1.10:1.0 |

The different fabrics (woven Cotton, at 140 g/m² and non-woven-Cotton-Viscose, at 90-110 gm²) were evaluated for cleaning (dry, without lubricant), specifically regarding fabric disintegration or shedding. The major findings were:
Non-woven fabrics were found to shed excessive amounts of fibers.
Woven Cotton fabrics were found to shed few fibers after use.

Table 2 presents the testing of different lubrication-impregnated fabrics (NW1-6 and W1-5), by 4 different evaluators (1-4).

TABLE 2
Evaluation of lubricating activity of
lubricant-impregnated fabrics.

| Sample | 1 | 2 | 3 | 4 |
|---|---|---|---|---|
| NW1 | 3 | 3 | 3 | 3 |
| NW2 | 3 | 3 | 3 | 3 |
| NW3 | 1 | 1 | 1 | 1 |
| NW4 | 1 | 1 | 1 | 1 |
| NW5 | 1 | 1 | 1 | 1 |
| NW6 | 1 | 1 | 1 | 1 |
| W1 | 3 | 3 | 3 | 3 |
| W2 | 2 | 3 | 3 | 3 |
| W3 | 2 | 2 | 2 | 2 |
| W4 | 1 | 1 | 1 | 2 |
| W5 | 1 | 1 | 1 | 1 |

### Legend:

1. Amount of lubricant is insufficient
2. Amount of lubricant is sufficient
3. Amount of lubricant is excessive or superfluous

Table 1 shows that non-woven fabrics were not able to provide the correct amount of lubricant for lubrication. Table 1 further shows that the lubricant-to-fabric ratio of between 0.8:1.0 to 1.0:1.0 was best (samples W2, W3, and W4).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will prevail. In addition, the materials, methods, and examples are illustrative only and are not intended to be necessarily limiting.

As used herein the terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Throughout this application various publications, published patent applications and published patents are referenced. The disclosures of these publications in their entireties are hereby incorporated by reference into this application in order to more fully describe the state of the art to which this invention pertains.

Certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1.-48. (canceled)

49. An article for cleaning and/or lubricating a weapon, comprising a sealable container, a woven lint-free fabric, and a lubricant; wherein the fabric is impregnated with the lubricant, and wherein the fabric comprises between 90% to 100% cotton and the fabric-to-lubricant ratio is in the range of 0.5:1 to 1:0.5.

50. The article of claim 49, wherein said fabric-to-lubricant ratio is in the range of 1:1 to 1:0.8, and/or wherein said fabric is characterized by at least one of: being partially napped, being fully napped, being napped on one side, being pre-cut, being partially pre-cut, being perforated, or any combination thereof.

51. The article of claim 49, wherein said fabric is characterized by at least one of: a warp density in the range of 30/1 to 35/1 threads, a warp density in the range of 19-to-23 threads per cm², weft density in the range of 30/1 to 35/1 threads, weft density in the range of 19-to-23 threads per cm², a weight of 125 to 150 g/m², a weight of 137±15 g/m², plain or twill weave, having less than 2% starch and protein, a warp breaking strength of at least 45 pounds, a weft breaking strength of at least 30 pounds, a warp dry tearing strength of at least 880 grams, a weft dry tearing strength of at least 480 grams, containing 250 parts per million (ppm) or less of water leachable sulfur, containing 250 ppm or less of each of water leachable halides (fluoride, chloride, and bromide), being free from loose threads, ravelings, lint and fluff; or any combination thereof.

52. The article of claim 49, wherein said fabric conforms to any one of MIL-DTL-24671A/B/C, MIL-DTL-24671, MIL-C-24671, NSN 7920-00-044-9281, NSN 7920-01-470-3786, and/or wherein said lubricant conforms to at least one of VV-L-800, VV-L-800A, VV-L-800B, VV-L-800C, VV-L-820, MIL-PRF-32033, MIL-PRF-32033A or MIL-PRF-14107.

53. The article of claim 49, wherein the fabric is in the form of a continuous strip or a roll, and wherein the strip or the roll comprises partially attached segments.

54. The article of claim 49, wherein said fabric is rolled, folded, continuously folded, stacked, and/or in the form of a plurality of segments.

55. The article of claim 54, wherein the plurality of segments are partially connected, loosely connected, detached, partially detached, interconnected, forming a web, or any combination thereof; and/or, wherein when the plurality of segments are partially connected, the attachment length is in the range of 1 to 20 percent of the segment width.

56. The article of claim 49, wherein said lubricant is characterized by having at least one of: a viscosity index of 40±10 at 40° C., a density of 0.879±0.3 g/m³, a flashpoint of at least 135° C., a lowest pour point of less than −60° C., an evaporation loss of less than 25%, at 100° C. a maximum precipitation number of the insoluble materials of less than 0.05 ml, low temperature stability at −45° C. for at least 72 hours, stability in contact with water, or any combination thereof, and/or wherein said lubricant is characterized by at least one of: being capable of inhibiting rusting of ferrous metals for at least 400 hours in a high humidity environment, being capable of preventing corrosion following 192 hours in humid conditions, does not precipitate or separate when the oil is stored at −54° C. for 168 hours, does not precipitate or separate when stored for six months at 18.3° to 35° C., having kinematic viscosity of at least 11 centistokes at 40° C., having kinematic viscosity of no more than 7,000 centistokes at −40° C., having kinematic viscosity of no more than 60,000 centistokes at −54° C., or any combination thereof.

57. The article of claim 49, wherein said sealable container is selected from the group consisting of bucket, box, bag, packet, jar, dispenser, pouch, barrel, can, drum and tub, and/or wherein the sealable container is made of nylon, plastic, rubber, metal, or silicon, and/or wherein the sealable container has at least one opening, and/or wherein the at least one opening is sealed with a lid, and/or wherein the lid comprises a second resealable opening, and/or wherein the lid can be attached or detached from the container by a mechanism selected from the group consisting of screw threads, snap fit, and clips.

58. The article of claim 57, wherein said at least one opening is in the form of a slit, and/or wherein the slit is configured to sever the fabric at the slit as the fabric passes through the slit.

59. A method of producing a lubricant-impregnated fabric for cleaning and/or lubricating a weapon, comprising:
a. providing a lint-free fabric comprising from 90% to 100% cotton, and a lubricant;
b. applying said lubricant to said fabric in the ratio in the range of 0.5:1 to 1:0.5 fabric-to-lubricant; and,
c. placing said lubricant-impregnated fabric in an air and/or liquid tight sealable container.

60. The method of claim 59, wherein the lubricant-impregnated fabric is in the form of a continuous strip, and wherein the method further comprises a step of pre-cutting, partially pre-cutting or perforating said continuous strip at predetermined intervals.

61. The method of claim 60, wherein said step of precutting comprises cutting at least 80% of the width of said continuous strip, and/or wherein the step of precutting is performed by a blade, pins, needles, laser, or any combination thereof; and/or wherein when the step of precutting is performed by a blade, the blade is toothed and/or serrated.

62. The method of claim 59, wherein the lubricant impregnated fabric is partially napped, fully napped, napped on one side, or any combination thereof; and/or wherein said lubricant impregnated fabric is characterized by at least one of: a warp density in the range of 30/1 to 35/1 threads, a warp density in the range of 19-to-21 threads per cm², weft density of 30-35/1 threads, weft density in the range of 20-to-22 threads per cm², weight of 125 to 150 g/m², a weight of 137±15 g/m², having plain or twill weave, having less than 2% starch and protein, warp breaking strength of at least 20 Kg. (45 pounds), weft breaking strength of at least 13.5 Kg. (30 pounds), warp dry tearing strength of at least 880 grams, a weft dry tearing strength of at least 480 grams, containing 250 parts per million (ppm) or less of water leachable sulfur, containing 250 ppm or less of each of water leachable halides (fluoride, chloride, and bromide), being free from loose threads, ravelings, lint and fluff; or any combination thereof; and/or wherein said lubricant-impregnated fabric conforms to any one of MIL-DTL-24671, MIL-DTL-24671A, MIL-DTL-24671B, MIL-DTL-24671C, MIL-DTL-24671, MIL-C-24671, NSN 7920-00-044-9281, and NSN 7920-01-470-3786.

63. The method of claim 59, wherein said lubricant is characterized by having at least one of: a viscosity index of 40±10 at 40° C., a density of 0.879±0.3 g/m³, a flashpoint of at least 135° C., a lowest pour point of less than −60° C., an evaporation loss of less than 25%, at 100° C. a maximum precipitation number of the insoluble materials of less than 0.05 ml, low temperature stability at −45° C. for at least 72 hours, stability in contact with water, or any combination thereof; and/or wherein said lubricant is characterized by at least one of: being capable of inhibiting rusting of ferrous metals for at least 400 hours in a high humidity environment, being capable of preventing corrosion following 192 hours in humid conditions, does not precipitate or separate when the oil is stored at −54° C. for 168 hours, does not precipitate or separate when stored for six months at 18.3° to 35° C.; and/or wherein said lubricant is characterized by having kinematic viscosity of: at least 11 centistokes at 40° C., no more than 7,000 centistokes at −40° C., and no more than 60,000 centistokes at −54° C.; and/or wherein said lubricant conforms to VV-L-800, VV-L-800A, VV-L-800B, VV-L-800C, VV-L-820, MIL-PRF-32033, MIL-PRF-32033A, or MIL-PRF-14107 specification.

64. The method of claim 63, wherein said lubricant is characterized as having a flashpoint of 190° C.

65. The method of claim 59, wherein said sealable container is selected from the group consisting of bucket, box, bag, packet, jar, dispenser, barrel, can, drum and tub; and/or wherein said container has at least one opening; and/or wherein the at least one opening is resealable; and/or wherein the at least one opening is sealed with a lid, and wherein the lid comprises a second resealable opening.

66. A method of lubricating a weapon, comprising the steps of:
a. providing the article of claim 49;
b. extracting at least one segment of the fabric from the container; and
c. applying lubricant to the weapon by means of the fabric;
Wherein said fabric comprises a dose of lubricant sufficient to lubricate and/or clean the weapon.
